(19) United States
(12) Patent Application Publication
(10) Pub. No.: US 2005/0114684 A1
(43) Pub. Date: May 26, 2005

(54) Contents use frequency limiting method, contents using terminal apparatus, contents using system, computer program and computer readable memory medium

(75) Inventor: Hajime Ohno, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/989,317

(22) Filed: Nov. 17, 2004

(30) Foreign Application Priority Data
Nov. 21, 2003 (JP) 2003-392727

(51) Int. Cl. H04L 9/00; H04L 9/32

(52) U.S. Cl. 713/187

(57) ABSTRACT

In a terminal device utilizing contents-having a limitation in the use frequency, an encrypted electronic file containing the contents is decrypted, then the decrypted electronic file is interpreted and the contents are outputted in a usable form. A set of an encryption key and a decryption key is generated at or after the output of the contents, then the decrypted electronic file is re-encrypted with the generated encryption key, and the re-encrypted electronic file is stored while the generation decryption key is outputted.

### BACKGROUND OF THE INVENTION

1. Field of the Invention

The present invention relates to a contents use frequency limiting method, a contents using terminal apparatus, a contents using system, a computer program and a computer readable memory medium, particularly adapted for use in limiting a use frequency of contents.

2. Related Background Art

A prior method for limiting frequency of use of contents is described in Japanese Patent Application Laid-open No. 2003-67651.

A use status of the contents in a client is transmitted from the client to a server, which manages the use frequency at the client. When the use frequency reaches a limit, the server does not transmit a use permission notice for the contents to the client, thereby limiting the use frequency of the contents.

Also there is known a technology of controlling a print frequency, at a client, of an electronic form distributed from a server to the client. In this technology, an ID stored as an attribute in the electronic form file and a print frequency upper limit value are copied in a print history file at a first printing, and a print frequency is stored in correlation therewith in the print history file. In a second or subsequent printing, the print history file is searched by the ID of the electronic form file to be printed and a corresponding print frequency is compared with the print frequency upper limit to discriminate whether the printing is permitted, and, if the printing is permitted, a printing process is executed with an increment of the print frequency.

An electronic file is generally very inexpensive in costs for copying or distribution. Consequently, an electronic file containing confidential information, once transferred to a third person other than authorized personnel, may be divulged widely, whereby the owner of the electronic file encounters a serious risk. In order to avoid such situation, it is necessary that the content of the electronic file cannot be known to a third person even when the electronic file itself is transferred to such third person. An encryption of the electronic file is usually employed for attaining such object.

However, in case of a simply encryption of the electronic file, a decryption key for utilizing the encrypted electronic file has to be transferred to the user. Therefore a simple encryption of the electronic file cannot sufficiently alleviate the risk in case unspecified plural users are expected or in case the user cannot be fully relied on.

Such situation can actually occur in a business handled by an agency, such as a commercial trade of a financial product, not involving movement of a tangible product. It is therefore desired, for such a user, to a leak of the information of the electronic file by limiting the opportunity or the method for utilizing the content of the electronic file and by elevating a cost or a barrier for improper use. In order to minimize such risk, a limitation on the use frequency of the electronic file is easily understandable for both the manager and the user of the information.

Also for realizing the limitation on the use frequency of the electronic file, it has been common, as in the prior technology described in Japanese Patent Application Laid-open No. 2003-67651, to construct a use system of an electronic file with a server and a client and to transmit, signals and data necessary for using the electronic file, from the server to the client.

However, such method of limiting the use frequency of the electronic file is associated with a drawback that a network connection is required for each use.

Also in order to restrict the frequency of communication between the client and the server while limiting the use frequency of the electronic file, there is known a method of storing a history of the use frequency of the electronic file as a local file in the client.

In this method, however, the use history file storing the history of the use frequency is not protected at all. Therefore, there results a drawback that, if the user copies the use history file before using the electronic file and overwrites the new use history file with the copies history file after the use of the electronic file, the memorized use frequency returns to the original value.

### SUMMARY OF THE INVENTION

The present invention has been made in consideration of the aforementioned drawbacks, and is to achieve easy and secure limitation on the use frequency of contents contained in an electronic file.

Thus, an object of the present invention is to provide a contents using terminal apparatus including a decryption unit for decrypting an encrypted electronic file containing contents, a first output unit for interpreting the electronic file decrypted by the decrypting unit and outputting the contents in a usable form, a generation unit for generating a set of an encryption key and a decryption key at or after the output of the contents by the first output means, a re-encryption unit for re-encrypting, utilizing the encryption key generated by the generation unit, the electronic file decrypted by the decryption unit, a storage unit for storing the encrypted electronic file re-encrypted by the re-encryption unit, and a second output unit for outputting the decryption key generated by the generation unit.

Another object of the present invention is to provide a contents using terminal apparatus including a decryption unit for decrypting an encrypted electronic file containing contents and a remaining use frequency value, a first output unit for interpreting the electronic file decrypted by the decrypting unit and outputting the contents in a usable form, a generation unit for generating a set of an encryption key and a decryption key based on a random number at or after the output of the contents by the first output means, a use frequency renewal unit for renewing the remaining use frequency value of the contents at the output of the contents by the first output unit, a re-encryption unit for re-encrypting, in case the remaining use frequency value for the contents changed by the use frequency renewal unit is not 0, the electronic file decrypted by the decryption unit, utilizing the encryption key generated by the generation unit, a storage unit for storing the encrypted electronic file re-encrypted by the re-encryption unit, and a second output unit for outputting the decryption key generated by the generation unit, in case the remaining use frequency value for the contents changed by the use frequency renewal unit is not 0.

Another object of the present invention is to provide a contents using terminal apparatus including a decryption unit for decrypting an encrypted electronic file containing contents and a number of sets of an encryption key and a decryption corresponding to an upper limit value of the use frequency of the contents, a first output unit for interpreting the electronic file decrypted by the decrypting unit and outputting the contents in a usable form, a re-encryption unit for re-encrypting, utilizing the encryption key, the electronic file decrypted by the decryption unit, a storage unit for storing the encrypted electronic file re-encrypted by the re-encryption unit, a decryption key acquisition unit for obtaining a decryption key paired with the encryption key employed in the re-encryption unit, a second output unit for outputting the decryption key obtained by the decryption key acquisition unit, and a deletion unit for deleting, in case one or more sets of the encryption key and the decryption key are identified to be present in the electronic file, one of such sets from the electronic file.

Still other objects of the present invention, and the features and advantages thereof, will become fully apparent from the following detailed description which is to be taken in conjunction with the accompanying drawings.

### BRIEF DESCRIPTION OF THE DRAWINGS

FIG. 1 is a schematic view showing a structure of a form printing system embodying the present invention;

FIG. 2 is a flow chart indicating a first embodiment of the present invention and showing an example of operations of a form server when a request is received from a client PC;

FIG. 3 is a view indicating the first embodiment of the present invention and showing an example of the content of form data delivered from the form server to the client PC;

FIG. 4 is a flow chart indicating the first embodiment of the present invention and showing an example of a process when the client PC receives form data and executes a first printing on form body data contained in the received form data;

FIG. 5 is comprised of FIGS. 5A and 5B showing flow charts indicating the first embodiment of the present invention and showing an example of a process when a second or subsequent printing is executed on the form body data contained in the form data;

FIG. 6 is a flow chart indicating the first embodiment of the present invention and showing a concept of a process for printing the form body data contained in the form data;

FIG. 7 is a flow chart indicating a second embodiment of the present invention and showing an example of operations of a form server when a request is received from a client PC;

FIG. 8 is a view indicating the second embodiment of the present invention and showing an example of the content of form data delivered from the form server to the client PC;

FIG. 9 is a flow chart indicating the second embodiment of the present invention and showing an example of a process when the client PC receives form data and executes a first printing on form body data contained in the received form data;

FIG. 10 is comprised of FIGS. 10A and 10B showing flow charts indicating the second embodiment of the present invention and showing an example of a process when a second or subsequent printing is executed on the form body data contained in the form data;

FIG. 11 is a flow chart indicating a third embodiment of the present invention and showing an example of operations of a form server when a request is received from a client PC;

FIG. 12 is a view indicating the third embodiment of the present invention and showing an example of the content of form data delivered from the form server to the client PC;

FIG. 13 is a flow chart indicating the third embodiment of the present invention and showing an example of a process when the client PC receives form data and executes a first printing on form body data contained in the received form data;

FIG. 14 comprised of FIGS. 14A and 14B showing flow charts indicating the third embodiment of the present invention and showing an example of a process when a second or subsequent printing is executed on the form body data contained in the form data; and

FIG. 15 is a block diagram indicating an embodiment of the present invention and showing an example of a structure of a computer system provided in the form server and the client PC.

### DESCRIPTION OF THE PREFERRED EMBODIMENTS

In the following, embodiments of the present invention will be explained with reference to the accompanying drawings. In the following embodiments, there will be explained a case where the contents are a business form, but the contents are naturally not limited to such form.

### First Embodiment

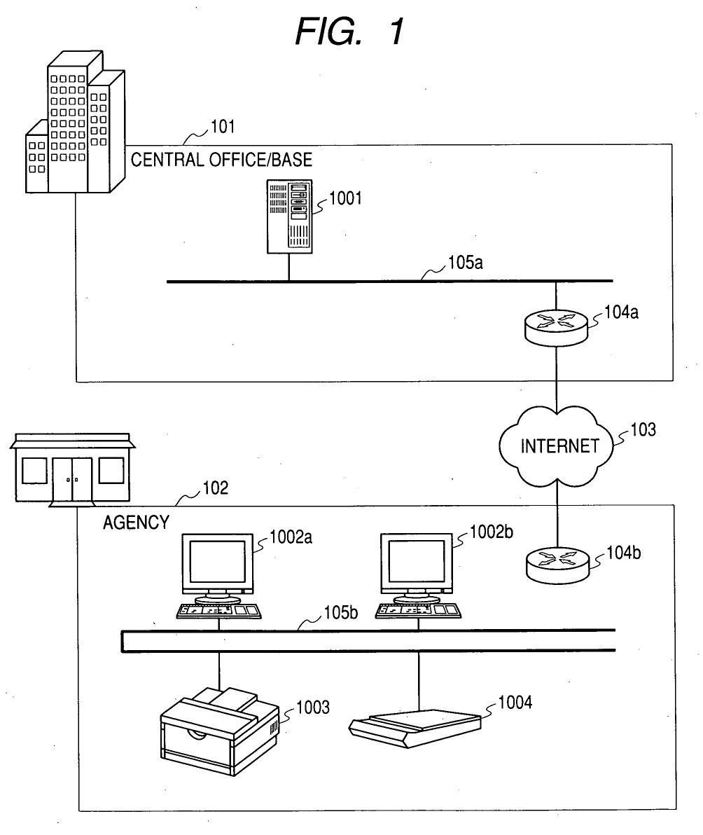

FIG. 1 is a view showing an example of a structure of a form printing system embodying the present invention. Referring to FIG. 1, the form printing system is constituted of a form server 1001 positioned in a central office/base 101, client PCs 1002a, 1002b, a printer 1003, and a scanner 1004 positioned in an agency 102, all connected communicably by an internet 103, routers 104a, 104b and LANs 105a, 105b.

In the following description, the client PCs 1002a and/or 1002b is abbreviated as a client PC 1002. Also the number of the client PCs is naturally not limited to two.

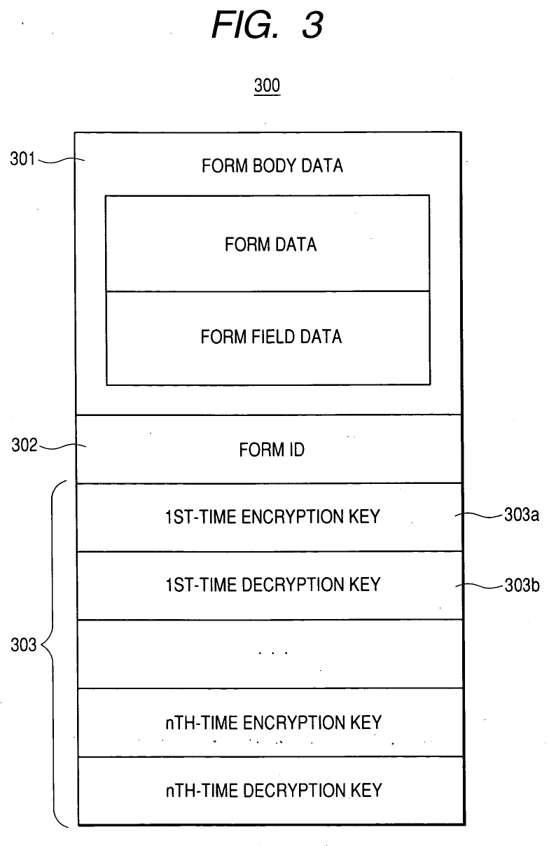

The form server 1001 generates and stores a form, and has a function, in response to a request from the client PC 1002, of delivering form data 300 which are formed by attaching a form ID 302 and key pairs 303 of encryption keys and decryption keys of a use frequency number to form body data 301 shown in FIG. 3, to the client PC 1002.

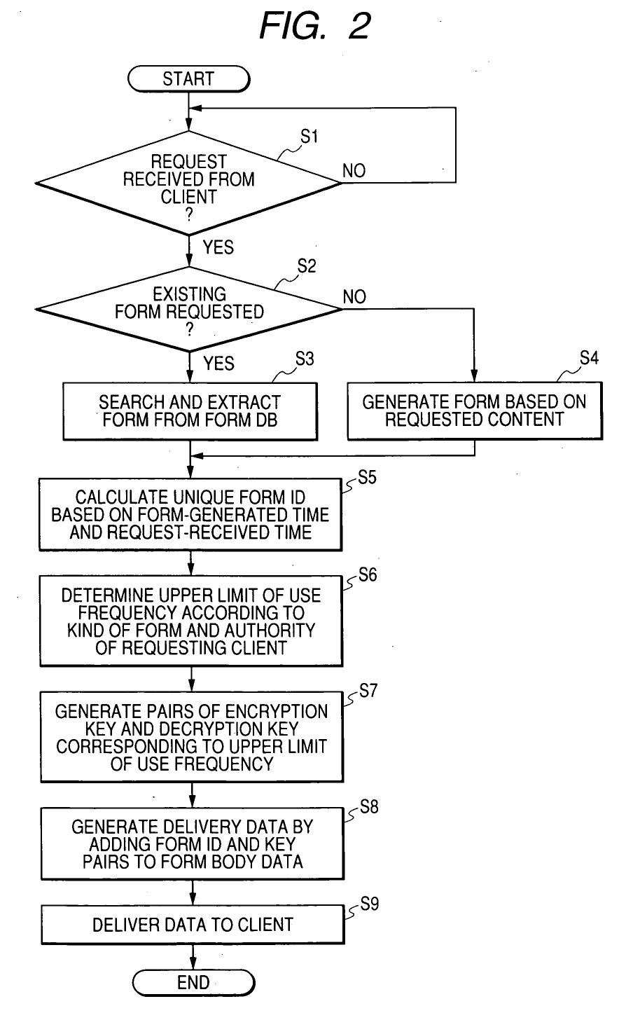

FIG. 2 is a flow chart showing operations of the form server 1001 when a request is received from the client PC 1002 in the present embodiment. This flow chart is executed by an unillustrated CPU of the form server 1001.

At first, a step S1 waits until an HTTP request is received from the client PC 1002. When an HTTP request is received, the sequence proceeds to a step S2 to analyze the content of the HTTP request received in the step S1 and to discriminate whether the received HTTP request is same as an HTTP request received in the past.

As a result of such discrimination, if it is same, the sequence proceeds to a step S3 to obtain, utilizing the HTTP request received in the step S1 as a key, form body data 301 and a generation time thereof from a form DB provided in the form server 1001.

On the other hand, if it is not same, the sequence proceeds to a step S4 to generate form body data 301 based on the content of the HTTP request received in the step S1. Then the generated form body data 301 and a generation time thereof are stored in the form DB utilizing the HTTP request as a key. Such storage is executed for enabling the form body data to be used in the future.

Then a step S5 generates a unique form ID 302 from the generation time of the form body data 301 and the receiving time (time of reception of the HTTP request in the step S1) of the request (HTTP request).

The generation time of the form body data 301 is used for the generation of the form ID 302, in order to form a unique form ID 302 for each form body data 301. Also the request receiving time is used for forming a unique form ID 302 for each request from the client PC.

Then a step S6 determines a use frequency upper limit value from a table prepared in advance, based on the kind of the form body data 301, the client PC 1002 that has issued the HTTP request, and an authority of a person who has issued the HTTP request.

The kind of the form body data 301 is identified for example if the data correspond to an important document relating to a monetary amount. Also the client PC 1002 is identified by an emitting IP address of the request, for example an HTTP request from a client PC 1002 of an upper manager, or an HTTP request from a client PC 1002 of a sales agency. The authority of the person who has issued the HTTP request is identified by specifying a person through an individual authentication utilizing SSL. The identifying method is naturally not limited to such examples.

Also by determining the use frequency upper limit by the client PC 1002 and a right given to a user thereof, it is naturally not necessary to determine the use frequency upper limit based on the kind of the form body data 301, the client PC 1002 that has issued the HTTP request, and the authority of the person who has issued the HTTP request. It is possible, for example, to determine the use frequency upper limit based on one or two of the kind of the form body data 301, the client PC 1002 that has issued the HTTP request, and the authority of the person who has issued the HTTP request.

Then a step S7 generates a key pair 303 of an encryption key and a decryption key by a number of the print frequency upper limit.

Then a step S8 generates delivery data (form data) 300 by attaching, to the form body data 301 obtained in the step S3 or S4, the key pairs 303 generated in the step S7 and the form ID 302 generated in the step S5.

Finally, a step S9 delivers the delivery data (form data) 300 generated in the step S8, to the client PC 1002 which is the transmission source of the HTTP request received in the step S1. The form data 300, delivered from the form server 1001 to the client PC 1002 in the step S2, have a content as shown in FIG. 3.

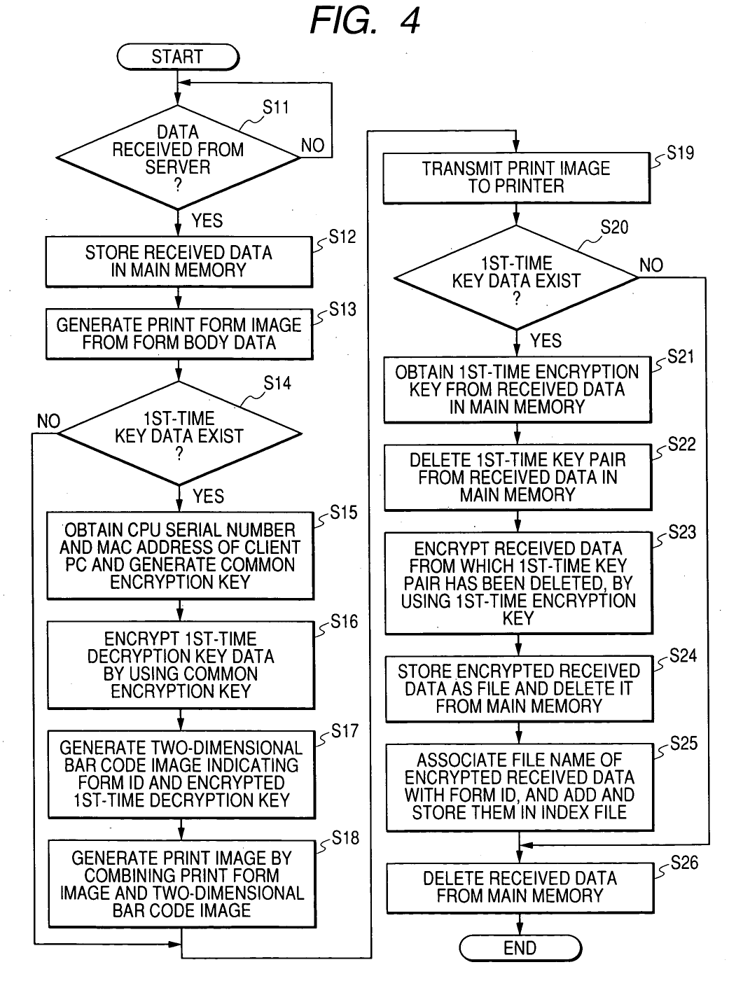

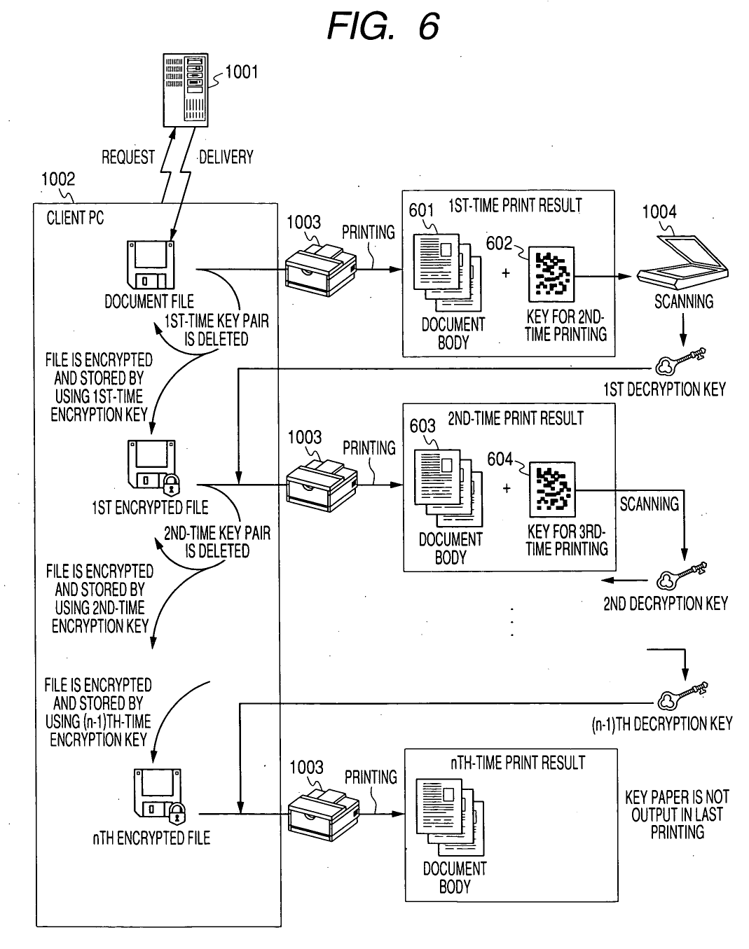

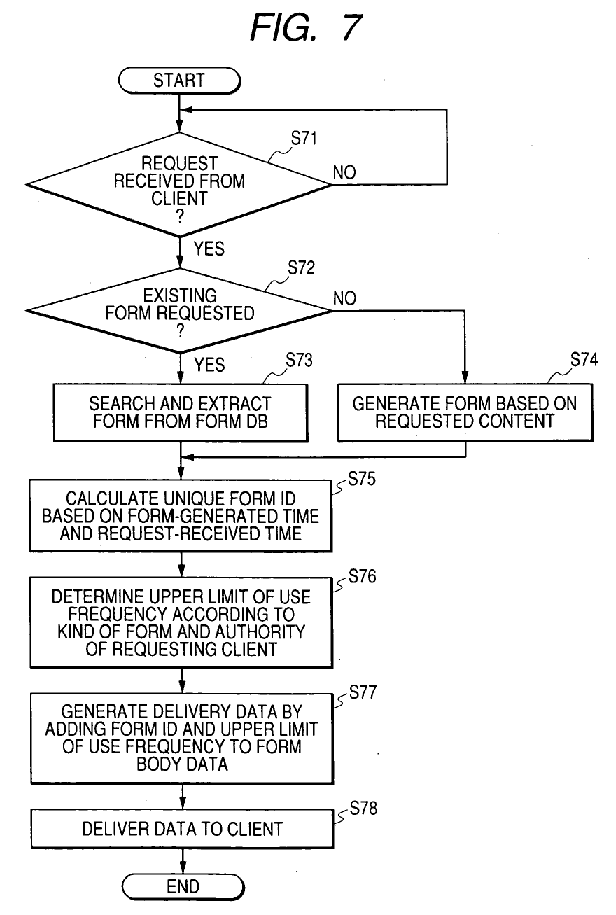

Then operations of the client PC 1002 that have received the deliver data (form data) 300, the printer 1003 and the scanner 1004 will be explained with reference to FIGS. 4 to 6. FIG. 4 is a flow chart showing a process sequence when the client PC 1002 receives the delivery data (form data) 300 and executes a first printing on form body data 301 contained in the received form data 300, the flow chart being executed by a CPU of the client PC 1002. FIG. 6 is a flow chart showing a concept of a process for printing the form body data 301 contained in the form data 300. More specifically FIG. 6 shows a concept in case a print frequency upper limit set at n.

At first a step S11 waits until the delivery data (form data) 300 are received from the form server 1001. When the form data 300 are received, the sequence proceeds to a step S12 and the client PC 1002 stores the form data 300, received in the step S11, in a main memory.

Then a step S13 generates print form image data based on the form body data 301, contained in the form data 300 stored in the main memory in the step S12.

In a step S14, the client PC 1002 discriminates whether the form data 300 stored in the main memory in the step S12 contains a key pair constituted of a first encryption key 303a and a first decryption key 303b. In case the discrimination identifies that the key pair constituted of the first encryption key 303a and the first decryption key 303b is not contained, the sequence skips steps S15-S18 to be explained later and proceeds to a step S19.

On the other hand, in case the key pair constituted of the first encryption key 303a and the first decryption key 303b is contained, the sequence proceeds to a step S15 and the client PC 1002 obtains information specific to the client environment and generates (calculates) a common encryption key based on the obtained information specific to the client environment. The information specific to the client environment is for example a CPU serial number and a MAC address of the client PC 1002. Also the information specific to the client environment need not necessarily be obtained in this step but may be obtained in the step S11. Also the common encryption key employed in the present embodiment is a key utilizing in encryption/decryption of a common key encryption method such as DES or triple DES, but other encryption methods may also be employed.

Then the sequence proceeds to a step S16 to encrypt the first decryption key 303b with the common encryption key generated in the step S15.

Then, in a step S17, the client PC 1002 converts the form ID 302 contained in the form data 300 stored in the main memory in the step S12 and the first decryption key 303b encrypted in the step S16 into a two-dimensional bar code, thereby generating two-dimensional bar code data, which are required, as will be explained later, for executing a second printing.

In a step S18, the client PC 1002 combines the print form image data generated in the step S13 and the two-dimensional bar code image data generated in the step S17 to generate print image data.

In a step S19, the client PC 1002 transmits the print image data generated in the step S18 to the printer 1003. The printer 1003 executes printing of the print form image data and the two-dimensional bar code image data as a set. In this manner print form data 601 and a two-dimensional bar code image (key paper) 602 are printed on a paper. In the present embodiment, the print form data 601 and the two-dimensional bar code image 602 are printed on a paper in such a manner that the two-dimensional bar code image 602 forms a last page separate from the form.

In a step S20, the client PC 1002 discriminates whether the form data 300 stored in the main memory in the step S12 contains a key pair constituted of a first encryption key 303a and a first decryption key 303b. In case the discrimination identifies that the key pair constituted of the first encryption key 303a and the first decryption key 303b is not contained, the sequence skips steps S21-S25 to be explained later and proceeds to a step S26.

On the other hand, in case the key pair constituted of the first encryption key 303a and the first decryption key 303b is contained, the sequence proceeds to a step S21 and the client PC. 1002 obtains the first encryption key 303a and the first decryption key 303b stored in the main memory.

Then, in a step S22, the client PC 1002 deletes the key pair constituted of the first encryption key 303a and the first decryption key 303b from the main memory. Then, in a step S23, the client PC 1002 encrypts the form data 300, from which the key pair is deleted in the step S22, with the first encryption key 303a obtained in the step S21.

In a step S24, the client PC 1002 stores the form data 300, from which the first key pair is deleted in the step S22 and which are encrypted in the step S23, as a file in a hard disk or the like, and deletes the original form data 300 stored in the main memory.

In a step S25, the client PC 1002 associates a file name of the form data 300 stored in the step S24 and the form ID 302 contained therein and stores them in an index file. Such associated storage of the file name of the form data 300 and the form ID 302 in the index file allows a prompt identification of the form file in case of re-printing by designating the form ID 302 next time.

Finally, in a step S26, the client PC 1002 erases the original data stored in the main memory in the step S12.

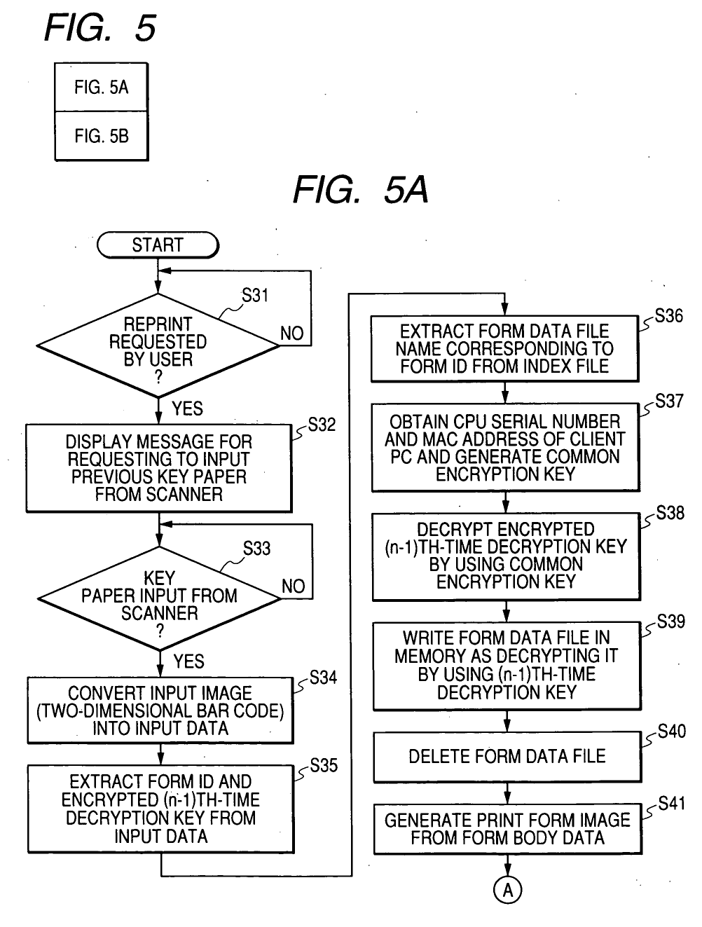

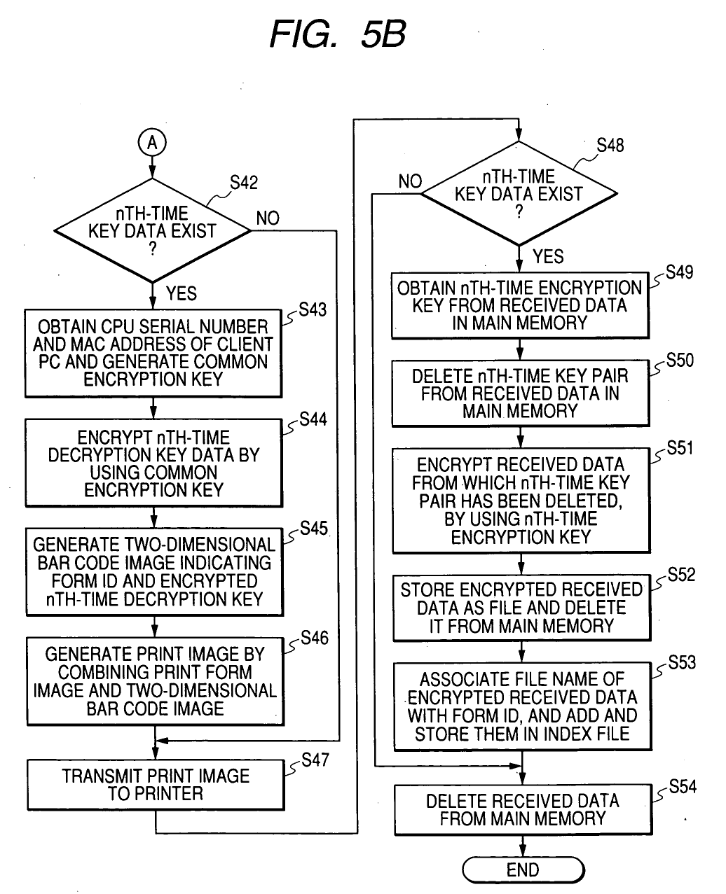

In the following, there will be explained a process when a second or subsequent printing is executed on the form body data 301 contained in the form data 300 with reference to flow charts shown in FIGS. 5A and 5B.

At first a step S31 waits until a reprint request is made from the user based on an operation of a keyboard or a mouse. When a reprint request is made, the sequence proceeds to a step S32 and the client PC 1002 displays, on a monitor, a message requesting the key paper outputted simultaneously at the previous form printing (for example the two-dimensional bar code image 602 printed in the step S19 shown in FIG. 4) is inputted from the scanner 104.

Then in a step S33, the client PC 1002 waits until the two-dimensional bar code image 602 is inputted from the scanner 104. When the two-dimensional bar code image 602 is inputted from the scanner 104, the sequence proceeds to a step S34 and the client PC 1002 executes an image processing on the two-dimensional bar code image inputted in the step S33 to obtain binary data.

In a step S35, the client PC 1002 extracts, from the binary data converted from the two-dimensional bar code image in the step S34, the form ID 302 and the encrypted (n−1)th decryption key (for example first decryption key). In the foregoing description, n indicates a current print frequency.

In a step S36, the client PC 1002 extracts, from the index file, a form data file name corresponding to the form ID 302 extracted in the step S35.

In a step S37, the client PC 1002 obtains information specific to the client environment and generates (calculates) a common encryption key based on the obtained information specific to the client environment. The information specific to the client environment is for example a CPU serial number and a MAC address of the client PC 1002.

In a step S38, the client PC 1002 decrypts the (n−1)th decryption key, with the common encryption key generated in the step S37.

In a step S39, the client PC 1002 decrypts the form data 300, stored as a file (hereinafter called form data file), with the (n−1)th decryption key decrypted in the step S38 and writes the decrypted form data file in the memory.

In a step S40, the client PC 1002 deletes the original form data file.

In a step S41, the client PC 1002 generates print form image data from the form body data 301, contained in the form data file written in the memory in the step S39.

Then, in a step S42, the client PC 1002 discriminates whether the form data file written in the memory in the step S39 contains a key pair constituted of an n-th encryption key and an n-th decryption key. In case the discrimination identifies that the key pair constituted of the n-th encryption key and the n-th decryption key is not contained, the sequence skips steps S43-S46 to be explained later and proceeds to a step S47.

On the other hand, in case the key pair constituted of the n-th encryption key and the n-th decryption key is contained, the sequence proceeds to a step S43 and the client PC 1002 obtains information specific to the client environment and generates (calculates) a common encryption key based on the obtained information specific to the client environment. The information specific to the client environment is for example a CPU serial number and a MAC address of the client PC 1002.

Then, in a step S44, the client PC 1002 encrypts the n-th decryption key with the common encryption key generated in the step S43.

Then, in a step S45, the client PC 1002 converts the form ID 302 contained in the form data file stored in the memory in the step S35 and the n-th decryption key encrypted in the step S44 into a two-dimensional bar code, thereby generating two-dimensional bar code data, which are required, as will be explained later, for executing an (n+1)th printing.

Then, in a step S46, the client PC 1002 generates print image data based on the print form image data generated in the step S41 and the two-dimensional bar code image data generated in the step S45.

In a step S47, the client PC 1002 transmits the print image data generated in the step S46 to the printer 1003. The printer 1003 executes printing of the print form image data and the two-dimensional bar code image data as a set. For example, in case the current printing is a second printing, a print form image 603 and a two-dimensional bar code image (key paper) 604 are printed on a paper.

In a step S48, the client PC 1002 discriminates whether the main memory contains a key pair constituted of an n-th encryption key and an n-th decryption key. In case the discrimination identifies that the key pair constituted of the n-th encryption key and the n-th decryption key is not contained, the sequence skips steps S49-S53 to be explained later and proceeds to a step S54.

On the other hand, in case the key pair constituted of the n-th encryption key and the n-th decryption key is contained, the sequence proceeds to a step S49 and the client PC 1002 obtains the n-th encryption key stored in the main memory.

Then, in a step S50, the client PC 1002 deletes the key pair constituted of the n-th encryption key and the n-th decryption key from the main memory.

Then, in a step S51, the client PC 1002 encrypts the form data 300, from which the key pair is deleted in the step S50, with the n-th encryption key obtained in the step S51.

In a step S52, the client PC 1002 stores the form data 300, from which the n-th key pair is deleted in the step S50 and which were encrypted in the step S51, as a file, and deletes the original form data 300 stored in the main memory.

In a step S53, the client PC 1002 associates a file name of the form data 300 stored in the step S52 and the form ID 302 contained therein and stores them in an index file.

Finally, in a step S54, the original data stored in the main memory are deleted.

In this manner, when the n-th key pair is not stored in the form data 300, a two-dimensional bar code image (key paper) for a next printing is not printed, and the form data 300 are not stored again, so that a repeated printing becomes impossible.

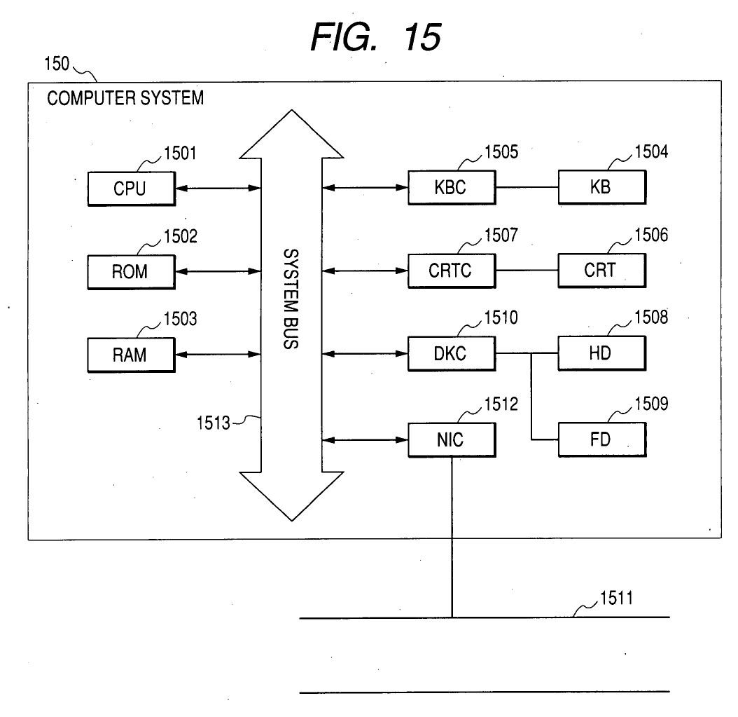

The software process (function) in the form server 1001 and the client PC 1002 explained above can be realized in a computer system as shown in FIG. 15.

FIG. 15 is a block diagram showing an example of the structure of a computer system provided in the form server 1001 and the client PC 1002.

Referring to FIG. 15, a computer system 150 is provided with a CPU 1501, a ROM 1502, a RAM 1503, a keyboard controller (KBC) 1505 for a keyboard (KB) 1504, a CRT controller (CRTC) 1507 for a CRT display (CRT) 1506 constituting a display unit, a disk controller (DKC) 1510 for a hard disk (HD) 1508 and a flexible disk (FD) 1509 and a network interface controller (NIC) 1512 for connection with a network 1511, and these components are mutually communicably connected through a system bus 1513.

The CPU 1501 integrally controls the components connected to the system bus 1503, by executing a software stored in the ROM 1502 or the HD 1508, or a software supplied from the FD 1509.

Thus the CPU 1501 reads and executes a process program of a predetermined process sequence from the ROM 1502, the HD 1508 or the FD 1509 thereby controlling the functions of the apparatus.

The RAM 1503 functions as a main memory or a work area for the CPU 1501. The KBC 1505 controls an instruction input from the KB 1504 or from an unillustrated pointing device.

The CRTC 1507 controls a display on the CRT.

The DKC 1510 controls an access to the HD 1508 and the FD 1509 which stores a boot program, various applications, an editing file, user files, a network management program and predetermined process programs.

The NIC 1512 executes a bi-directional data exchange with a device or a system on the network 1511.

In the present embodiment, as explained in the foregoing, the form server 1001 delivers the form data 300 in response to the request from the client PC 1002. The client PC 1002, receiving the delivered form data 300, generates form print image data from the form body data 301 contained in the form data 300, also generates the two-dimensional bar code image data from the form ID 302 contained in the form data 300 and the n-th decryption key, and prints the form print image 601, 603 and the two-dimensional bar code image 602, 604. It then deletes the key pair, constituted of the n-th encryption key and the n-th decryption key contained in the form data 300. In a subsequent printing, the form body data 301 is decrypted utilizing the two-dimensional bar code image 602, 604.

Thus, in the repetitive use of the form body data 301, the re-use (re-print) of the form body data 301 is permitted only to a person who has the two-dimensional bar code image 602, 604. Also the frequency of the printing of the form body data 301 is limited to the number of the key pairs. Furthermore, the frequency of the printing of the form body data 301 can be managed by the client PC 1002.

It is therefore rendered possible, while minimizing the number of communications between the form server 1001 and the client PC 1002, to limit the number of printing of the form body data 301 more securely than in the prior technology, and to present an improper re-use of the form body data 301 as far as possible.

Particularly in the present embodiment, it is possible to effectively avoid the improper re-use of the form body data 301, since, after the printing, the form data 300 from which the key pair constituted of the n-th encryption key and the n-th decryption key is removed is re-encrypted and the re-encrypted form data 300 are stored as a file while the original form data 300 are deleted.

Also, the decryption key, contained in the key pair corresponding to the current printing is encrypted with the common encryption key generated from a CPU serial number and a MAC address, and the encrypted decryption key is outputted as information necessary for a next printing (two-dimensional bar code image 602, 604). Then, at a next printing, the two-dimensional bar code image 602, 604 is entered and is decrypted by the common encryption key generated from the CPU serial number and the MAC address. Then thus decrypted two-dimensional bar code image 602, 604 is used to decrypt the form data 301. In this manner, the second or subsequent use is enabled only in a client environment which used the form body data (contents) 301 in the first time, and the security against an improper use, an improper copying and an improper distribution can be improved.

In the present embodiment, improper reuse of the form body data 301 is effectively prevented by deleting the original form data 300, but it is also possible to overwrite the original form data 300 with the re-encrypted form data 300.

Also in the present embodiment, a two-dimensional bar code image is used for preventing the improper reuse in the next and subsequent printing, but an electronic watermark may be employed instead of the two-dimensional bar code image.

Also in the present embodiment, the encryption key and the decryption key are made mutually different, but it is also possible to utilize a common key encryption in which the encryption key and the decryption key are same.

### Second Embodiment

In the following, a second embodiment of the present invention will be explained. In contrast to the foregoing first embodiment in which the print frequency is restricted by the number of the key pairs 303, the present embodiment attaches an upper limit value of print frequency to the form data and limits the print frequency utilizing such upper limit value of print frequency. Also in contrast to the foregoing first embodiment in which the form server 1001 generates the key pair, the present embodiment generates the key pair in the client PC. Since the present embodiment is different from the first embodiment only in a part of the software process, in the following description, portions same as those in the foregoing first embodiment will be represented by corresponding symbols as in FIGS. 1 to 5A and 5B and will not be explained in detail.

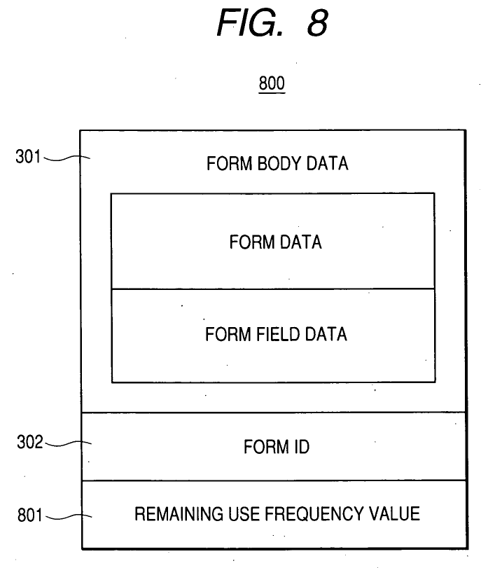

FIG. 8 is a view showing an example of the content of form data delivered in the present embodiment, in which form data 800, constituted of form body data 301, a form ID 302 and a remaining use (print) frequency of the form data 800, are delivered from the form server 1001 to the client PC 1002.

In the following, there will be explained, with reference to a flow chart shown in FIG. 7, an example of operations of the form server 1001 when a request is received from the client PC 1002.

In FIG. 7, steps S71-S76 are same as the steps S1-S6 shown in FIG. 3.

When a step S71 receives an HTTP request from the client PC 1002, the sequence proceeds to a step S72 to discriminate whether the received HTTP request is same as an HTTP request received in the past.

As a result of such discrimination, if it is same, the sequence proceeds to a step S73 to obtain form body data 301 and a generation time thereof from a form DB provided in the form server 1001.

On the other hand, if it is not same, the sequence proceeds to a step S74 to generate form body data 301 based on the content of the HTTP request and to store the generated form body data 301 and the generation time thereof.

Then a step S75 generates a unique form ID 302 from the generation time of the form body data 301 and the receiving time of the request.

Then a step S76 determines a use frequency upper limit value, based on the kind of the form body data 301, the client PC 1002 that has issued the HTTP request, and an authority of a person who has issued the HTTP request.

Then a step S77 generates delivery data (form data) 800 by attaching the form ID 302 generated in the step S75 and the print frequency upper limit determined in the step S76 to the form body data 301.

Finally, a step S78 delivers the delivery data (form data) 800 generated in the step S77, to the client PC 1002 which is the transmission source of the HTTP request received in the step S71.

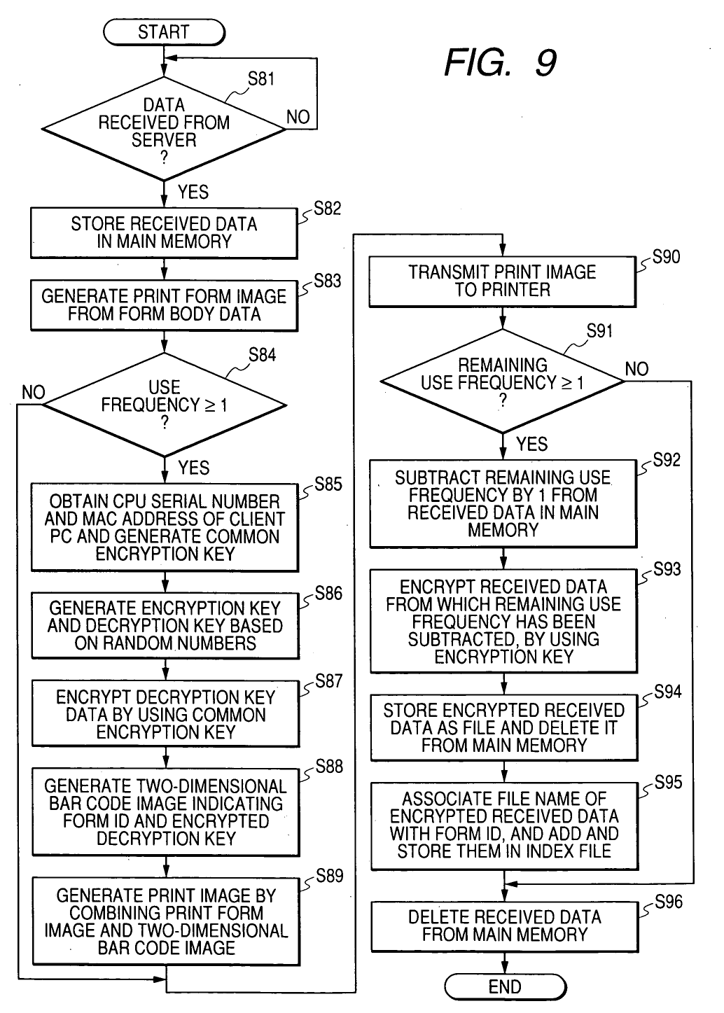

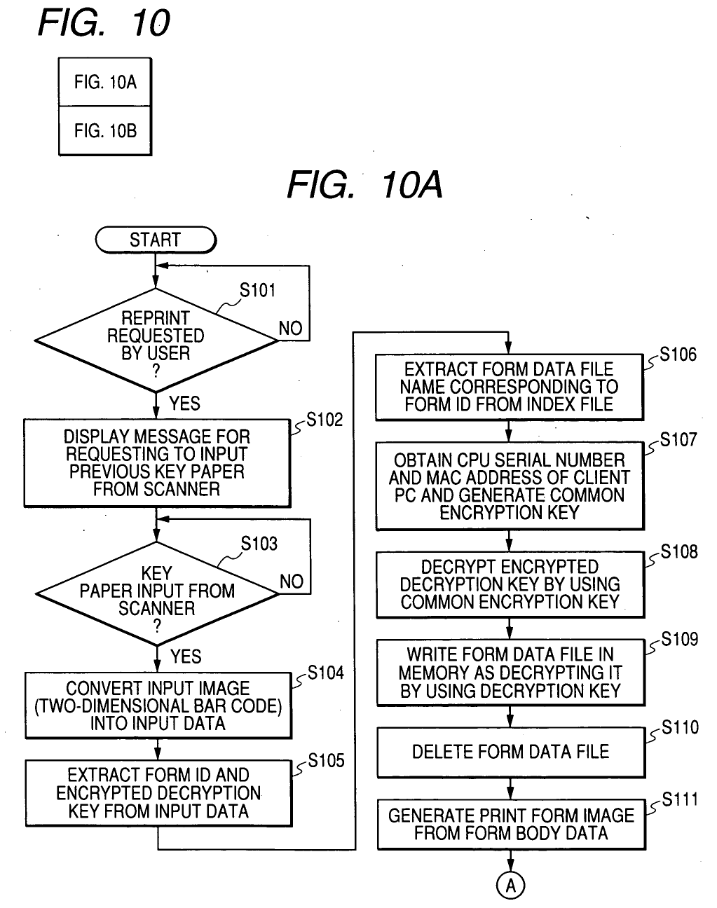

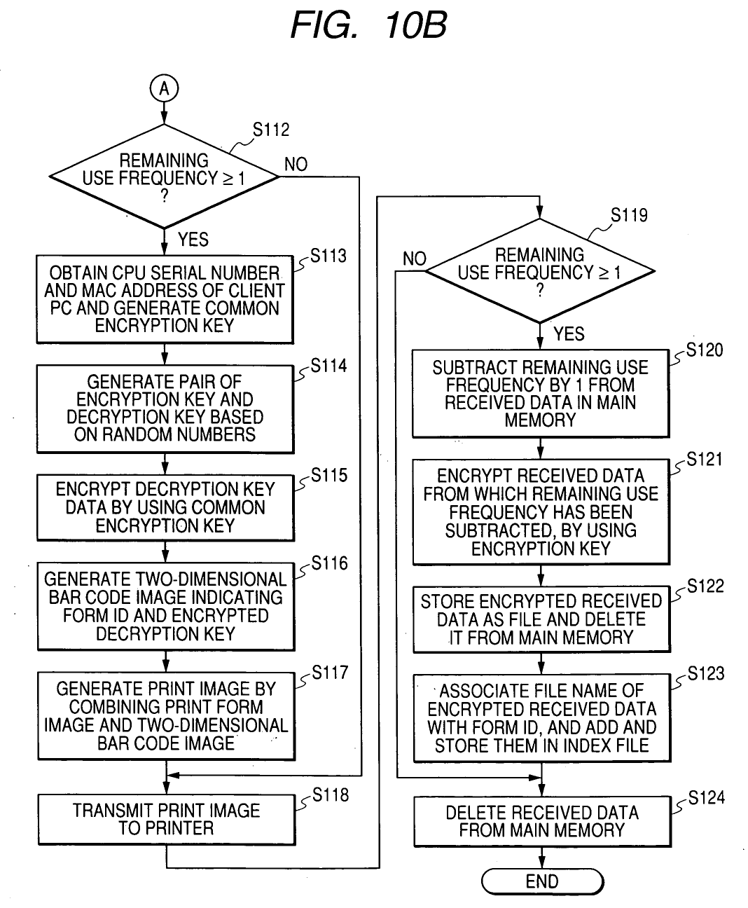

Then operations of the client PC 1002 that have received the deliver data (form data) 800, the printer 1003 and the scanner 1004 will be explained with reference to FIGS. 9, 10A and 10B.

FIG. 9 is a flow chart showing a process in which the client PC 1002 receives the delivered data (form data) 800 and executes a first printing of the form body data 301 contained in the received form data 800.

In FIG. 9, steps S81-S83 are same as the steps S11-S13 shown in FIG. 4.

At first when a step S81 receives the delivery data (form data) 800 from the form server, the client PC 1002 in a step S82 stores the received form data 800 in a main memory, and, in a step S83, generates print form image data based on the form body data 301, contained in the stored form data 800.

In a step S84, the client PC 1002 discriminates whether a print frequency upper limit (remaining use frequency) 801, attached to the form data 800 stored in the main memory in the step S82, is 1 or larger. In case the discrimination identifies that the print frequency upper limit (remaining use frequency) 801 is not 1 nor larger (namely 0), the sequence skips steps S85-S89 to be explained later and proceeds to a step S90.

On the other hand, in case the print frequency upper limit (remaining use frequency) 801 is 1 or larger, the sequence proceeds to a step S85 and the client PC 1002 generates (calculates) a common encryption key as in the step S15 shown in FIG. 4.

Then, in a step S86, the client PC 1002 generates a key pair of an encryption key and a decryption key utilizing a random number.

Then, in a step S87, the client PC 1002 encrypts the decryption key generated in the step S86 with the common encryption key generated in the step S85.

Then, in a step S88, the client PC 1002 converts, as in the step S17 in FIG. 4, the form ID 302 contained in the form data 800 stored in the main memory in the step S82 and the decryption key encrypted in the step S87 into a two-dimensional bar code, thereby generating two-dimensional bar code data.

In a step S89, the client PC 1002, as in the step S18 shown in FIG. 4, generates print image data based on the print form image data generated in the step S83 and the two-dimensional bar code image data generated in the step S88.

In a step S90, the client PC 1002, as in the step S19 shown in FIG. 4, transmits the print image data generated in the step S89 to the printer 1003. The printer 1003 executes printing of the print form image data and the two-dimensional bar code image data as a set.

Then, in a step S91, the client PC 1002 discriminates whether a print frequency upper limit (remaining use frequency) 801, attached to the form data 800 stored in the main memory in the step S82, is 1 or larger. In case the discrimination identifies that the print frequency upper limit (remaining use frequency) 801 is not 1 nor larger (namely 0), the sequence skips steps S92-S95 to be explained later and proceeds to a step S96.

On the other hand, in case the print frequency upper limit (remaining use frequency) 801 is 1 or larger, the sequence proceeds to a step S92 and the client PC 1002 subtracts 1 from the print frequency upper limit (remaining use frequency) 801 attached to the form data 800 stored in the main memory.

Then, in a step S93, the client PC 1002 encrypts the form data 800, in which the print frequency upper limit (remaining use frequency) 801 is decreased by 1 in the step S92, with the encryption key generated in the step S86.

In a step S94, the client PC 1002 stores the form data 800, in which the print frequency upper limit (remaining use frequency) 801 is decreased by 1 in the step S92 and which are encrypted in the step S93, as a file, and deletes the original form data 800 stored in the main memory.

In a step S95, the client PC 1002, as in the step S24 shown in FIG. 4, associates a file name of the form data 800 stored in the step S94 and the form ID 302 contained therein and stores them in an index file.

Finally, in a step S96, the client PC 1002, as in the step S26 in FIG. 4, erases the original data stored in the main memory in the step S82.

In the following, there will be explained a process when a second or subsequent printing is executed on the form body data 301 contained in the form data 900 with reference to flow charts in FIGS. 10A and 10B.

In FIGS. 10A and 10B, steps S101-S105 are same as the steps S31-S34 shown in FIGS. 5A and 5B.

At first when the client PC 1002 receives a reprint request from the user in a step S101, the client PC 1002 in a step S102 requests an input of the key paper, outputted simultaneously at the previous form printing, from the scanner 104. When the two-dimensional bar code image 602 is inputted from the scanner 104 in a step S103, a step S104 converts the two-dimensional bar code image inputted in the step S103 into binary data.

In a step S105, the client PC 1002 extracts, from the binary data converted from the two-dimensional bar code image in the step S104, the form ID 302 and the encrypted decryption key.

In a step S106, the client PC 1002, as in the step S36 shown in FIGS. 5A and 5B, extracts from the index file a form data file name corresponding to the form ID 302 extracted in the step S105.

In a step S107, the client PC 1002, as in the step S37 shown in FIGS. 5A and 5B, generates (calculates) a common encryption key based on information specific to the client environment. The information specific to the client environment is for example a CPU serial number and a MAC address of the client PC 1002.

In a step S108, the client PC 1002 decrypts the decryption key extracted in the step S105, with the common encryption key generated in the step S107.

In a step S109, the client PC 1002 decrypts the form data 800, stored as a file (hereinafter called form data file), with the decryption key decrypted in the step S108 and writes the decrypted form data file in the memory.

In a step S110, the client PC 1002 deletes the original form data file, as in the step S40 shown in FIGS. 5A and 5B.

In a step S111, the client PC 1002, as in the step S41 in FIGS. 5A and 5B, generates print form image data from the form body data 301, contained in the form data file written in the memory in the step S109.

Then, in a step S112, the client PC 1002 discriminates whether a print frequency upper limit (remaining use frequency) 801, contained in the form data file stored in the memory in the step S109, is 1 or larger. In case the discrimination identifies that the print frequency upper limit (remaining use frequency) 801 is not 1 nor larger (namely 0), the sequence skips steps S113-S117 to be explained later and proceeds to a step S118.

On the other hand, in case the print frequency upper limit (remaining use frequency) 801 is 1 or larger, the sequence proceeds to a step S113 and the client PC 1002, as in the step S43 in FIGS. 5A and 5B, generates (calculates) a common encryption key based on information specific to the client environment. The information specific to the client environment is, for example, a CPU serial number and a MAC address of the client PC 1002.

Then, in a step S114, the client PC 1002 generates a key pair of an encryption key and a decryption key utilizing a random number.

Then, in a step S115, the client PC 1002 encrypts the decryption key generated in the step S114 with the common encryption key generated in the step S113.

Then, in a step S116, the client PC 1002 converts the form ID 302 contained in the form data file stored in the memory in the step S109 and the decryption key generated in the step S114 into a two-dimensional bar code, thereby generating two-dimensional bar code data.

In a step S117, the client PC 1002, as in the step S46 shown in FIGS. 5A and 5B, generates print image data based on the print form image data generated in the step S111 and the two-dimensional bar code image data generated in the step S116.

In a step S118, the client PC 1002, as in the step S47 shown in FIGS. 5A and 5B, transmits the print image data generated in the step S117 to the printer 1003. The printer 1003 executes printing of the print form image data and the two-dimensional bar code image data as a set.

Then, in a step S119, the client PC 1002 discriminates whether a print frequency upper limit (remaining use frequency) 801, attached to the form data 800 stored in the main memory, is 1 or larger. In case the discrimination identifies that the print frequency upper limit (remaining use frequency) 801 is not 1 nor larger (namely 0), the sequence skips steps S120-S123 to be explained later and proceeds to a step S124.

On the other hand, in case the print frequency upper limit (remaining use frequency) 801 is 1 or larger, the sequence proceeds to a step S120 and the client PC 1002 subtracts 1 from the print frequency upper limit (remaining use frequency) 801 attached to the form data 800 stored in the main memory.

Then, in a step S121, the client PC 1002 encrypts the form data 800, in which the print frequency upper limit (remaining use frequency) 801 is decreased by 1 in the step S120, with the encryption key generated in the step S114.

In a step S122, the client PC 1002 stores the form data 800, in which the print frequency upper limit (remaining use frequency) 801 is decreased by 1 in the step S120 and which are encrypted in the step S121, as a file, and deletes the original form data 800 stored in the main memory.

In a step S123, the client PC 1002, as in the step S95 shown in FIGS. 5A and 5B, associates a file name of the form data 800 stored in the step S122 and the form ID 302 contained therein and stores them in an index file.

Finally, in a step S124, the client PC 1002, as in the step S54 in FIGS. 5A and 5B, erases the original data stored in the main memory.

As explained in the foregoing, the present embodiment, in which the print frequency upper limit 801 is attached to the form data 800 and the print frequency is limited by such print frequency upper limit 801, provides an effect that the file size of the form data 800 does not change for each use, in addition to the effects of the aforementioned first embodiment.

Also, as in the aforementioned fist embodiment, it is possible to overwrite the original form data 300 with the re-encrypted form data 300 thereby effectively preventing an improper reuse of the form body data 301.

It is also possible to utilize an electronic watermark for preventing the improper reuse in the next and subsequent printing.

Also a common key encryption method in which the encryption key and the decryption key are same may be employed.

### Third Embodiment

In the following, a third embodiment of the present invention will be explained. In contrast to the foregoing first embodiment in which the data necessary for the next printing (two-dimensional bar code data) and the form body data 301 are outputted to a same destination, the present embodiment has different destinations. Since the present embodiment is different from the first embodiment only in a part of the software process, in the following description, portions same as those in the foregoing first embodiment will be represented by corresponding symbols as in FIGS. 1 to 6 and 15 and will not be explained in detail.

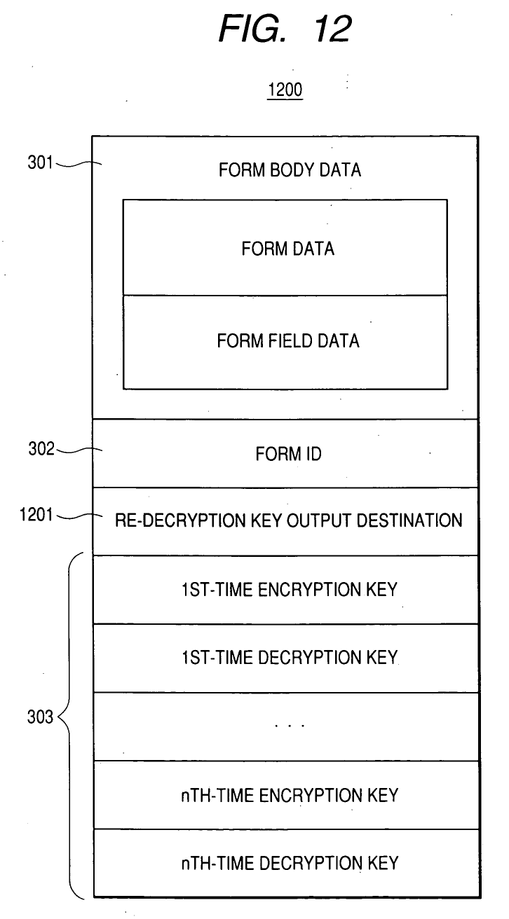

FIG. 12 is a view showing an example of the content of form data delivered in the present embodiment, in which form data 1200, constituted of form body data 301, a form ID 302, key pairs 303 of encryption keys and decryption keys, and data 1201 indicating a destination of data required for a next printing (hereinafter called re-decryption key), are delivered from the form server 1001 to the client PC 1002.

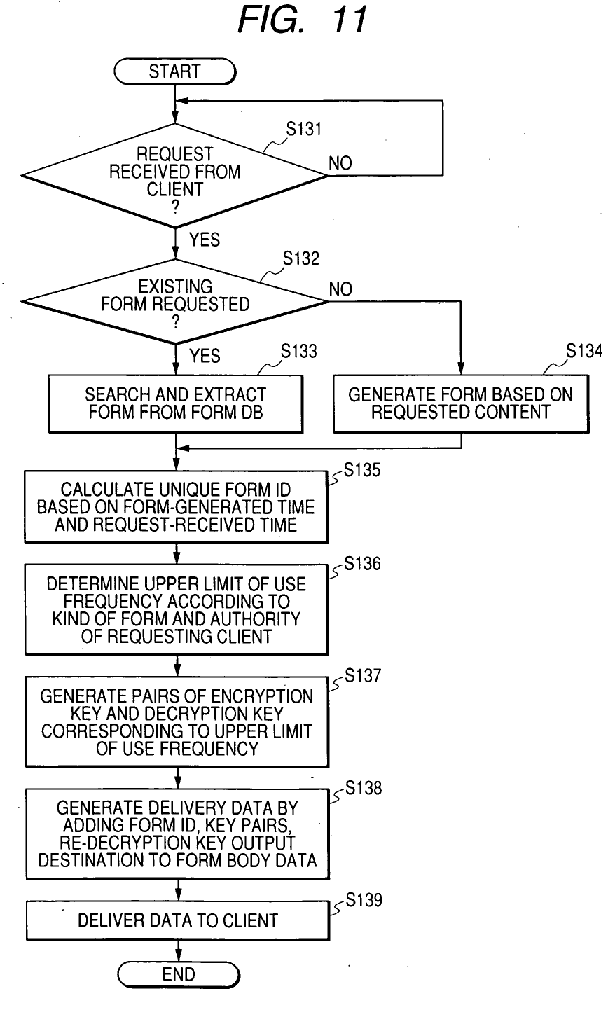

In the following, there will be explained, with reference to a flow chart shown in FIG. 11, an example of operations of the form server 1001 when a request is received from the client PC 1002.

In FIG. 11, steps S131-S137 are same as the steps S1-S6 shown in FIG. 3.

When a step S131 receives an HTTP request from the client PC 1002, the sequence proceeds to a step S132 to discriminate whether the received HTTP request is same as an HTTP request received in the past.

As a result of such discrimination, if it is same, the sequence proceeds to a step S133 to obtain form body data 301 and a generation time thereof from a form DB provided in the form server 1001.

On the other hand, if it is not same, the sequence proceeds to a step S134 to generate form body data 301 based on the content of the HTTP request and to store the generated form body data 301 and the generation time thereof.

Then a step S135 generates a unique form ID 302 from the generation time of the form body data 301 and the receiving time of the request.

Then a step S136 determines a use frequency upper limit value, based on the kind of the form body data 301, the client PC 1002 that has issued the HTTP request, and an authority of a person who has issued the HTTP request.

Then a step S137 generates a key pair 303 of an encryption key and a decryption key by a number of the print frequency upper limit value determined in the step S136.

Then, in a step S138, the client PC 1002 obtains a destination 1201 of the re-decryption key based on an operation of an input device (keyboard or mouse) by the user and generates delivery data (form data) 1200 by attaching the obtained destination 201 of the re-decryption key, the key pairs 303 generated in the step S137 and the form ID 302 generated in the step S135 to the form body data 301 obtained in the step S133 or S134.

Finally, a step S139 delivers the delivery data (form data) 1200 generated in the step S138, to the client PC 1002 which is the transmission source of the HTTP request received in the step S131.

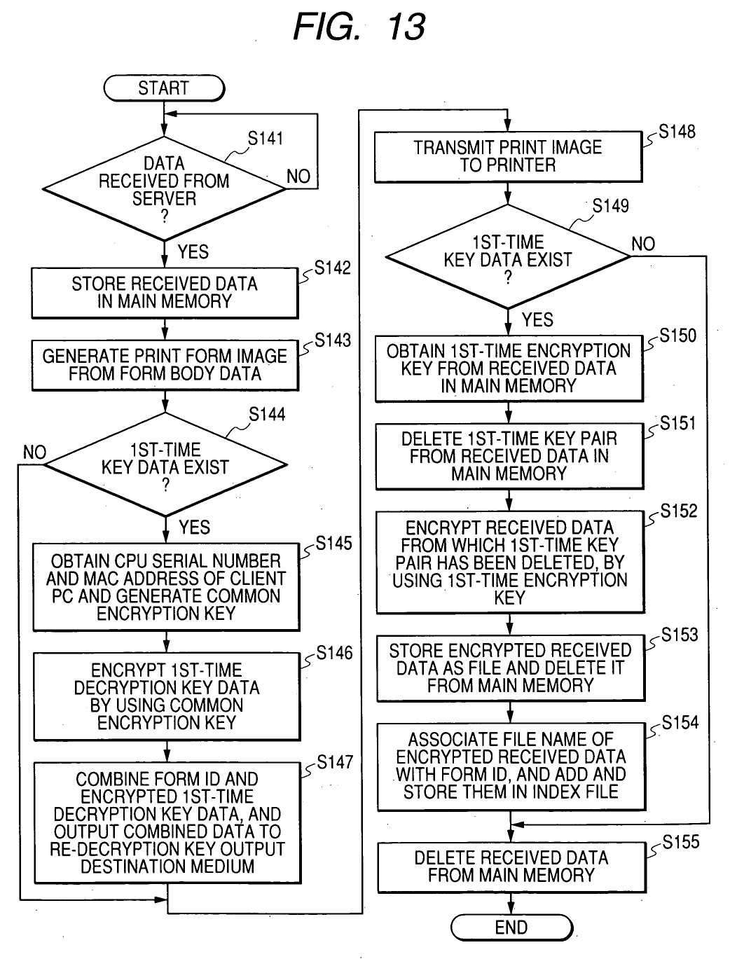

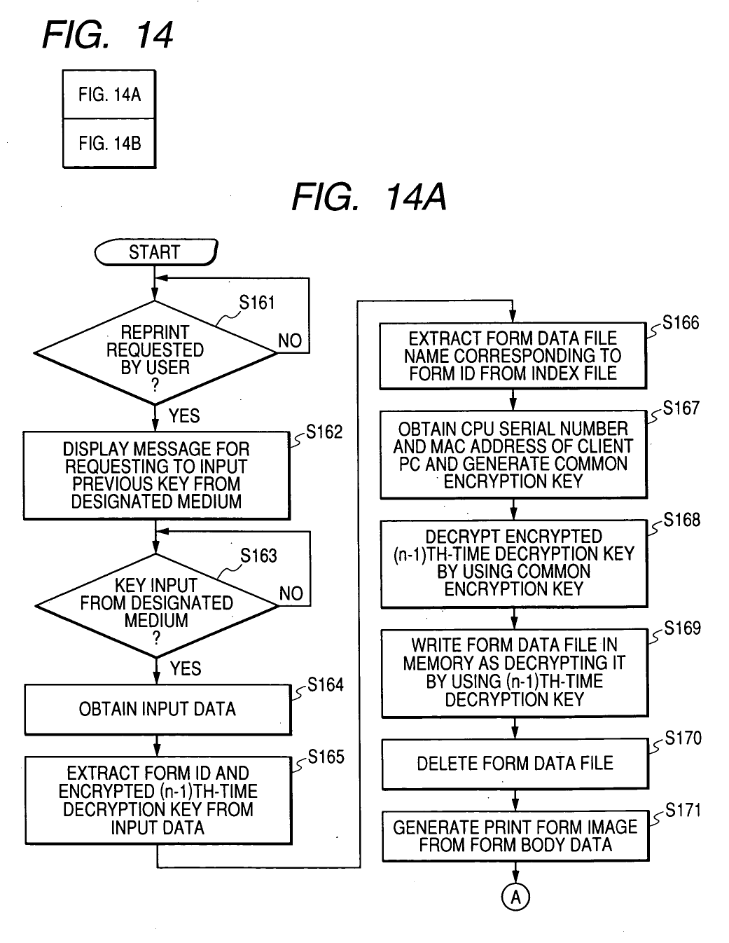

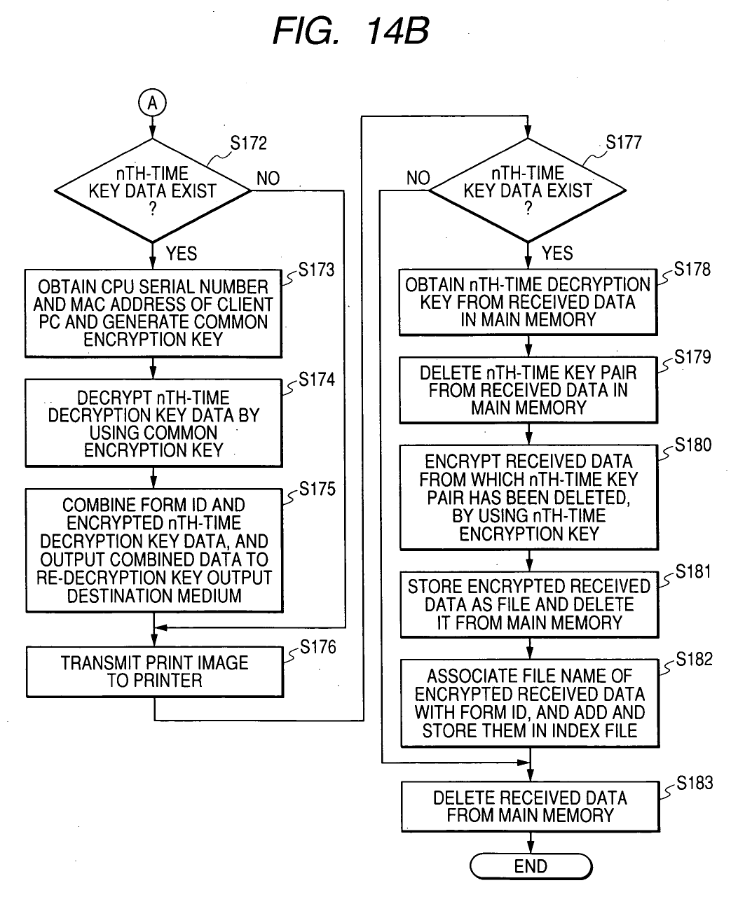

Then operations of the client PC 1002 that have received the deliver data (form data) 1200, the printer 1003 and the scanner 1004 will be explained with reference to FIGS. 13, 14A and 14B.

FIG. 13 is a flow chart showing a process in which the client PC 1002 receives the delivered data (form data) 1200 and executes a first printing of the form body data 301 contained in the received form data 1200.

In FIG. 13, steps S141-S146 are same as the steps S11-S16 shown in FIG. 4.

At first when a step S141 receives the delivery data (form data) 1200 from the form server 1001, the client PC 1002 in a step S142 stores the received form data 1200 in a main memory, and, in a step S143, generates print form image data based on the form body data 1201, contained in the stored form data 1200.

In a step S144, the client PC 1002 discriminates whether a first key pair is contained in the stored form data 1200. In case the discrimination identifies that the first key pair is not contained, the sequence skips steps S145-S147 to be explained later and proceeds to a step S148.

On the other hand, in case the first key pair is contained, the sequence proceeds to a step S145 and the client PC 1002 generates (calculates) a common encryption key based on information specific to the client environment. The information specific to the client environment is, for example, a CPU serial number and a MAC address of the client PC 1002.

Then, in a step S146, the client PC 1002 encrypts the first decryption key 303b with the common encryption key generated in the step S145.

Then, in a step S147, the client PC 1002 combines the form ID 302 contained in the form data 1200 stored in the main memory in the step S142 and the first decryption key encrypted in the step S146 and outputs the data to the destination 1201 contained in the form data 1200 stored in the main memory in the step S142.

In a step S148, the client PC 1002 transmits the print image data generated in the step S148 to the printer 1003. The printer 1003 executes printing of the print form image data.

The body of the contents (form body data 301) and the re-encryption key may be outputted in a same method or in different methods. Also the destination (designated medium) of the re-encryption key can be, for example, a flexible disk, a memory card or a punched card.

Following steps S149-S155 are same as the steps S20-S26 shown in FIG. 4.

In a step S149, the client PC 1002 discriminates whether the form data 1200 stored in the main memory contains a first key pair. In case the discrimination identifies that the first key pair is not contained, the sequence skips steps S150-S154 to be explained later and proceeds to a step S155.

On the other hand, in case the first key pair is contained, the sequence proceeds to a step S150 and the client PC 1002 obtains the first encryption key 303a stored in the main memory.

Then, in a step S151, the client PC 1002 deletes the first key pair from the main memory.

Then, in a step S152, the client PC 1002 encrypts the form data 1200, from which the first key pair is deleted, with the first encryption key 303a obtained in the step S150.

In a step S153, the client PC 1002 stores the form data 1200, from which the first key pair is deleted in the step S151 and which are encrypted in the step S152, as a file, and deletes the original form data 1200 stored in the main memory.

In a step S154, the client PC 1002 associates a file name of the form data 1200 stored in the step S153 and the form ID 302 contained therein and stores them in an index file.

Finally, in a step S155, the client PC 1002 erases the original data stored in the main memory in the step S142.

In the following, there will be explained a process when a second or subsequent printing is executed on the form body data 301 contained in the form data 1200 with reference to flow charts in FIGS. 14A and 14B.

In the following, there will be explained a process when a second or subsequent printing is executed on the form body data 301 contained in the form data 1200 with reference to flow charts in FIGS. 14A and 14B.

At first a step S161 waits, as in the step S101 shown in FIGS. 10A and 10B, until a reprint request is made from the user. When a reprint request is made, the sequence proceeds to a step S162 and the client PC 1002 displays, on a monitor, a message requesting an input of the re-encryption key from the designated medium.

Then in a step S163, the client PC 1002 waits until the re-encryption key is inputted from the designated medium. When it is inputted, the sequence proceeds to a step S164 and the client PC 1002 obtains the re-encryption key inputted in the step S163.

Following steps S165-S174 are same as the steps S35-S44 in FIGS. 5A and 5B.

In a step S165, the client PC 1002 extracts the form ID 302 and the encrypted (n−1)th decryption key.

In a step S166, the client PC 1002 extracts a form data file name corresponding to the form ID 302 extracted in the step S165.

In a step S167, the client PC 1002 generates (calculates) a common encryption key based on information specific to the client environment. The information specific to the client environment is for example a CPU serial number and a MAC address of the client PC 1002.

In a step S168, the client PC 1002 decrypts the (n−1)th decryption key extracted in the step S165, with the common encryption key generated in the step S167.

In a step S169, the client PC 1002 decrypts the form data 1200, stored as a file (hereinafter called form data file), with the (n−1)th decryption key decrypted in the step S168 and writes the decrypted form data file in the memory.

In a step S170, the client PC 1002 deletes the original form data file.

In a step S171, the client PC 1002 generates print form image data.

Then, in a step S172, the client PC 1002 discriminates whether the form data file written in the memory in the step S169 contains an n-th key pair. In case the discrimination identifies that the key pair is not contained, the sequence skips steps S173-S175 to be explained later and proceeds to a step S176.

On the other hand, in case the n-th key pair is contained, the sequence proceeds to a step S173 and the client PC 1002 generates (calculates) a common encryption key based on information specific to the client environment. The information specific to the client environment is for example a CPU serial number and a MAC address of the client PC 1002.

Then, in a step S174, the client PC 1002 encrypts the n-th decryption key with the common encryption key generated in the step S173.

Then, in a step S175, the client PC 1002 combines the form ID 302 contained in the form data 1200 decrypted in the step S169 and the n-th decryption key encrypted in the step S174 and outputs them to the destination 1201 of the re-decryption key contained in the form data 1200.

Following steps S176-S183 are same as the steps S47-S54 shown in FIGS. 5A and 5B.

In a step S176, the client PC 1002 transmits the print image data generated in the step S171 to the printer 1003. The printer 1003 executes printing of the print form image data.

In a step S177, the client PC 1002 discriminates whether the main memory contains an n-th key pair. In case the discrimination identifies that the n-th key pair is not contained, the sequence skips steps S178-S182 to be explained later and proceeds to a step S183.

On the other hand, in case the n-th key pair is contained, the sequence proceeds to a step S178 and the client PC 1002 obtains the n-th encryption key stored in the main memory.

Then, in a step S179, the client PC 1002 deletes the n-th key pair from the main memory.

Then, in a step S180, the client PC 1002 encrypts the form data 1200, from which the n-th key pair is deleted, with the n-th encryption key obtained in the step S178.

In a step S181, the client PC 1002 stores the form data 1200, from which the n-th key pair is deleted and which were encrypted, as a file, and deletes the original form data 1200 stored in the main memory.

In a step S182, the client PC 1002 associates a file name of the stored form data 1200 and the form ID 302 contained therein and stores them in an index file.

Finally, in a step S183, the original data stored in the main memory are deleted.

In the present embodiment as explained in the foregoing, the destination of the data required for the next printing (re-encryption key) and the destination of the form body data 301 are made different, so that the contents can be easily reused even in case the contents are not form body data but video data, in addition to the effects of the aforementioned first embodiment. More specifically, in the aforementioned first embodiment, in case the contents are not form body data 301 but video data or the like, it is difficult for the user to record the two-dimensional bar code as the data necessary for the next printing, displayed on the monitor, and to input it into the client PC 1002 at the next use, but the present embodiment can avoid such drawback.

As in the aforementioned first embodiment, it is possible to effectively prevent the improper reuse of the form body data 301 by overwriting the original form data 1200 with the re-encrypted form data 1200.

Also it is possible to utilize a common key encryption in which the encryption key and the decryption key are same.

### Other Embodiments

The objects of the present invention can naturally be attained also in a case where program codes of a software realizing the functions of the aforementioned embodiments is supplied to a computer in a system or an apparatus which is connected with various devices to operate the devices so as to realize the functions of the aforementioned embodiments and the functions of the aforementioned embodiments are realized by a computer (CPU or MPU) of the above-mentioned system or apparatus according to the program.

In such case the program codes themselves of the software realize the novel functions of the aforementioned embodiments, and the program codes themselves and the memory medium storing the program codes constitutes the present invention. The memory medium storing such program codes can be, for example, a flexible disk, a hard disk, an optical disk, a magnetooptical disk, a CD-ROM, a CD-R, a magnetic tape, a non-volatile memory card, or a ROM.

The present invention also includes not only a case where the functions of the aforementioned embodiments are realized by the execution of the program codes read by the computer but also a case where an operating system or the like functioning on the computer executes all or a part of the actual processes under the control of such program codes thereby realizing the functions of the aforementioned embodiments.

The present invention further includes a case wherein the program codes read from the memory medium are once stored in a function expansion board inserted into the computer or a function expansion unit connected to the computer, and a CPU provided in the function expansion board or the function expansion unit executes all the process or a part thereof under the control of such program codes, thereby realizing the functions of the aforementioned embodiments.

The present invention has been explained by preferred embodiments, but the present invention is not limited to such embodiments but is subject to modifications within the scope and spirit of the appended claims.

This application claims priority from Japanese Patent Application No. 2003-392727 filed Nov. 21, 2003, which is hereby incorporated by reference herein.

1. A contents use frequency limiting method comprising:
a decoding step of decrypting an encrypted electronic file containing contents;
a first output step of interpreting the electronic file decrypted by said decrypting step and outputting said contents in a usable form;
a generation step of generating a set of an encryption key and a decryption key at or after the output of the contents by said first output step;
a re-encryption step of re-encrypting, utilizing the encryption key generated by said generation step, the electronic file decrypted by said decryption step;
a storage step of storing the encrypted electronic file re-encrypted by said re-encryption unit; and
a second output step of outputting the decryption key generated by said generation unit.

2. A contents use frequency limiting method according to claim 1, further comprising:
a deletion step of deleting the original encrypted electronic file when the encrypted electronic file is stored in said storage step.

3. A contents use frequency limiting method according to claim 1, wherein:
said storage step stores said encrypted electronic file by overwriting the original encrypted electronic file.

4. A contents use frequency limiting method comprising:
a decryption step of decrypting an encrypted electronic file containing contents and a remaining use frequency value;
a first output step of interpreting the electronic file decrypted by said decrypting step and outputting said contents in a usable form;
a generation step of generating a set of an encryption key and a decryption key based on a random number at or after the output of the contents by said first output means;
a use frequency changing step of counting down the remaining use frequency value of said contents at the output of said contents by said first output step;
a re-encryption unit for re-encrypting, in case the remaining use frequency value for the contents changed by the use frequency changing step is not 0, the electronic file decrypted by said decryption step, utilizing the encryption key generated by said generation unit;
a storage step of storing the encrypted electronic file re-encrypted by said re-encryption unit; and
a second output step of outputting the decryption key generated by said generation unit, in case the remaining use frequency value for the contents changed by the use frequency changing step is not 0, and not outputting said contents nor said decryption key in case the remaining use frequency value for the contents changed by the use frequency changing step is 0.

5. A contents use frequency limiting method according to claim 4, further comprising:
a deletion step of deleting the original encrypted electronic file when the encrypted electronic file is stored in said storage step.

6. A contents use frequency limiting method according to claim 4, wherein:
said storage step stores said encrypted electronic file by overwriting the original encrypted electronic file.

7. A contents use frequency limiting method according to claim 4, further comprising:
an embedding step of embedding a destination of the decryption key, outputted by said second output step, in said electronic file;
wherein said second output step outputs the decryption key to the destination embedded by said embedding step.

8. A contents use frequency limiting method according to claim 4, further comprising:
a printing step of printing the decryption key, outputted by said second output step, as a two-dimensional bar code on a paper; and
a reading step of reading the two-dimensional bar code printed on the paper by said printing step.

9. A contents use frequency limiting method according to claim 4, further comprising:
a printing step of printing the decryption key, outputted by said second output step, as an electronic watermark on a paper; and
a reading step of reading the electronic watermark printed on the paper by said printing step.

10. A contents use frequency limiting method according to claim 4, further comprising:
an attribute obtaining step of obtaining an attribute specific to a client environment utilizing said contents;
a common encryption key generating step of generating a common encryption key based on the attribute obtained in said attribute obtaining step;
a decryption key encrypting step of encrypting said decryption key, utilizing the common encryption key generated in said common encryption key generating step;
an attribute re-obtaining step of obtaining again an attribute specific to a client environment utilizing said contents, in response to an input of the decryption key by said second output step;
a common encryption key re-generation step of re-generating a common encryption key, based on the attribute re-obtained by said attribute re-obtaining step; and
a decryption key decrypting step of decrypting said inputted decryption key, utilizing the common encryption key re-generated in said common encryption key re-generation step;
wherein said second output step outputs a decryption key encrypted in said decryption key encrypting step; and
said decryption step decrypts the encrypted electronic file, utilizing the decryption key decrypted in said decryption key decrypting step.

11. A contents use frequency limiting method according to claim 4, wherein:
said second output step outputs the decryption key together with the contents outputted by said first output step.

12. A contents use frequency limiting method comprising:
a decryption step of decrypting an encrypted electronic file containing contents and a number of sets of an encryption key and a decryption key corresponding to an upper limit value of the use frequency of said contents;
a first output step of interpreting the electronic file decrypted by said decrypting unit and outputting the contents in a usable form;
a re-encryption step of re-encrypting said electronic file utilizing said encryption key;
a storage step of storing the encrypted electronic file re-encrypted by said re-encryption step;
a decryption key obtaining step of obtaining a decryption key paired with the encryption key employed in said re-encryption unit;
a second output step of outputting the decryption key obtained by said decryption key obtaining step; and
a deletion step of deleting, in case one or more sets of the encryption key and the decryption key are identified to be present in said electronic file, one of said sets from said electronic file;
wherein said second output step does not output said contents nor said decryption key, in case no set of the encryption key and the decryption key is present in said electronic file.

13. A contents use frequency limiting method according to claim 12, further comprising:
a deletion step of deleting the original encrypted electronic file when the encrypted electronic file is stored in said storage step.

14. A contents use frequency limiting method according to claim 12, wherein:
said storage step stores said encrypted electronic file by overwriting the original encrypted electronic file.

15. A contents use frequency limiting method according to claim 12, further comprising:
an embedding step of embedding a destination of the decryption key, outputted by said second output step, in said electronic file;
wherein said second output step outputs the decryption key to the destination embedded by said embedding step.

16. A contents use frequency limiting method according to claim 12, further comprising:
a printing step of printing the decryption key, outputted by said second output step, as a two-dimensional bar code on a paper; and
a reading step of reading the two-dimensional bar code printed on the paper by said printing step.

17. A contents use frequency limiting method according to claim 12, further comprising:
a printing step of printing the decryption key, outputted by said second output step, as an electronic watermark on a paper; and
a reading step of reading the electronic watermark printed on the paper by said printing step.

18. A contents use frequency limiting method according to claim 12, further comprising:
an attribute obtaining step of obtaining an attribute specific to a client environment utilizing said contents;
a common encryption key generating step of generating a common encryption key based on the attribute obtained in said attribute obtaining step;
a decryption key encrypting step of encrypting said decryption key, utilizing the common encryption key generated in said common encryption key generating step;
an attribute re-obtaining step of obtaining again an attribute specific to a client environment utilizing said contents, in response to an input of the decryption key by said second output step;
a common encryption key re-generation step of re-generating a common encryption key, based on the attribute re-obtained by said attribute re-obtaining step; and
a decryption key decrypting step of decrypting said inputted decryption key, utilizing the common encryption key re-generated in said common encryption key re-generation step;
wherein said second output step outputs a decryption key encrypted in said decryption key encrypting step; and
said decryption step decrypts the encrypted electronic file, utilizing the decryption key decrypted in said decryption key decrypting step.

19. A contents use frequency limiting method according to claim 12, wherein:
said second output step outputs the decryption key together with the contents outputted by said first output step.

20. A contents using terminal apparatus comprising:
a decryption unit adapted to decrypt an encrypted electronic file containing contents;
a first output unit adapted to interpret the electronic file decrypted by said decrypting unit and output said contents in a usable form;
a generation unit adapted to generate a set of an encryption key and a decryption key at or after the output of the contents by said first output means;
a re-encryption unit adapted to re-encrypt, utilizing the encryption key generated by said generation unit, the electronic file decrypted by said decryption unit;
a storage unit adapted to store the encrypted electronic file re-encrypted by said re-encryption unit; and
a second output unit adapted to output the decryption key generated by said generation unit.

21. A contents using terminal apparatus comprising:
a decryption unit adapted to decrypt an encrypted electronic file containing contents and a remaining use frequency value;
a first output unit adapted to interpret the electronic file decrypted by said decrypting unit and output said contents in a usable form;
a generation unit adapted to generate a set of an encryption key and a decryption key based on a random number at or after the output of the contents by said first output means;
a use frequency changing unit adapted to change the remaining use frequency value of the contents at the output of the contents by said first output unit;
a re-encryption unit adapted to re-encrypt, in case the remaining use frequency value for the contents changed by the use frequency changing unit is not 0, the electronic file decrypted by said decryption unit, utilizing the encryption key generated by said generation unit;
a storage unit adapted to store the encrypted electronic file re-encrypted by said re-encryption unit; and
a second output unit adapted to output the decryption key generated by said generation unit, in case the remaining use frequency value for the contents changed by the use frequency changing unit is not 0.

22. A contents using terminal apparatus comprising:
a decryption unit adapted to decrypt an encrypted electronic file containing contents and a number of sets of an encryption key and a decryption key corresponding to an upper limit value of the use frequency of the contents;
a first output unit adapted to interpret the electronic file decrypted by said decrypting unit and output said contents in a usable form;
a re-encryption unit adapted to re-encrypt said electronic file utilizing said encryption key;
a storage unit adapted to store the encrypted electronic file re-encrypted by said re-encryption unit;
a decryption key obtaining unit adapted to obtain a decryption key paired with the encryption key employed in said re-encryption unit;
a second output unit adapted to output the decryption key obtained by said decryption key obtaining unit; and
a deletion unit adapted to delete, in case one or more sets of the encryption key and the decryption key are identified to be present in said electronic file, one of such sets from said electronic file.

23. A computer program for causing a computer to execute a contents use frequency limiting method which comprises:
a decoding step of decrypting an encrypted electronic file containing contents;
a first output step of interpreting the electronic file decrypted by said decrypting step and outputting said contents in a usable form;
a generation step of generating a set of an encryption key and a decryption key at or after the output of the contents by said first output step;
a re-encryption step of re-encrypting, utilizing the encryption key generated by said generation step, the electronic file decrypted by said decryption step;
a storage step of storing the encrypted electronic file re-encrypted by said re-encryption unit; and
a second output step of outputting the decryption key generated by said generation unit.

24. A computer program for causing a computer to execute a contents use frequency limiting method which comprises:
a decryption step of decrypting an encrypted electronic file containing contents and a remaining use frequency value;
a first output step of interpreting the electronic file decrypted by said decrypting step and outputting said contents in a usable form;
a generation step of generating a set of an encryption key and a decryption key based on a random number at or after the output of the contents by said first output means;
a use frequency changing step of counting down the remaining use frequency value of said contents at the output of said contents by said first output step;
a re-encryption unit for re-encrypting, in case the remaining use frequency value for the contents changed by the use frequency changing step is not 0, the electronic file decrypted by said decryption step, utilizing the encryption key generated by said generation unit;
a storage step of storing the encrypted electronic file re-encrypted by said re-encryption unit; and
a second output step of outputting the decryption key generated by said generation unit, in case the remaining use frequency value for the contents changed by the use frequency changing step is not 0, and not outputting said contents nor said decryption key in case the remaining use frequency value for the contents changed by the use frequency changing step is 0.

25. A computer program for causing a computer to execute a contents use frequency limiting method which comprises:
a decryption step of decrypting an encrypted electronic file containing contents and a number of sets of an encryption key and a decryption key corresponding to an upper limit value of the use frequency of said contents;
a first output step of interpreting the electronic file decrypted by said decrypting unit and outputting the contents in a usable form;
a re-encryption step of re-encrypting said electronic file utilizing said encryption key;
a storage step of storing the encrypted electronic file re-encrypted by said re-encryption step;
a decryption key obtaining step of obtaining a decryption key paired with the encryption key employed in said re-encryption unit;
a second output step of outputting the decryption key obtained by said decryption key obtaining step; and
a deletion step of deleting, in case one or more sets of the encryption key and the decryption key are identified to be present in said electronic file, one of said sets from said electronic file.

26. A computer readable memory medium which stores a computer program a computer program for causing a computer to execute a contents use frequency limiting method, the method comprising:
a decoding step of decrypting an encrypted electronic file containing contents;
a first output step of interpreting the electronic file decrypted by said decrypting step and outputting said contents in a usable form;
a generation step of generating a set of an encryption key and a decryption key at or after the output of the contents by said first output step;
a re-encryption step of re-encrypting, utilizing the encryption key generated by said generation step, the electronic file decrypted by said decryption step;
a storage step of storing the encrypted electronic file re-encrypted by said re-encryption unit; and
a second output step of outputting the decryption key generated by said generation unit.

27. A computer readable memory medium which stores a computer program a computer program for causing a computer to execute a contents use frequency limiting method, the method comprising:
a decryption step of decrypting an encrypted electronic file containing contents and a remaining use frequency value;
a first output step of interpreting the electronic file decrypted by said decrypting step and outputting said contents in a usable form;
a generation step of generating a set of an encryption key and a decryption key based on a random number at or after the output of the contents by said first output means;
a use frequency changing step of counting down the remaining use frequency value of said contents at the output of said contents by said first output step;
a re-encryption unit for re-encrypting, in case the remaining use frequency value for the contents changed by the use frequency changing step is not 0, the electronic file decrypted by said decryption step, utilizing the encryption key generated by said generation unit;
a storage step of storing the encrypted electronic file re-encrypted by said re-encryption unit; and
a second output step of outputting the decryption key generated by said generation unit, in case the remaining use frequency value for the contents changed by the use frequency changing step is not 0, and not outputting said contents nor said decryption key in case the remaining use frequency value for the contents changed by the use frequency changing step is 0.

28. A computer readable memory medium which stores a computer program a computer program for causing a computer to execute a contents use frequency limiting method, the method comprising:
a decryption step of decrypting an encrypted electronic file containing contents and a number of sets of an encryption key and a decryption key corresponding to an upper limit value of the use frequency of said contents;
a first output step of interpreting the electronic file decrypted by said decrypting unit and outputting the contents in a usable form;
a re-encryption step of re-encrypting said electronic file utilizing said encryption key;
a storage step of storing the encrypted electronic file re-encrypted by said re-encryption step;
a decryption key obtaining step of obtaining a decryption key paired with the encryption key employed in said re-encryption unit;
a second output step of outputting the decryption key obtained by said decryption key obtaining step; and
a deletion step of deleting, in case one or more sets of the encryption key and the decryption key are identified to be present in said electronic file, one of said sets from said electronic file.
